(19) United States
(12) Patent Application Publication
(10) Pub. No.: US 2021/0153712 A1
(43) Pub. Date: May 27, 2021

(54) CLEANING DEVICE FOR A FUEL TANK

(71) Applicant: DELPHI TECHNOLOGIES IP LIMITED, ST. MICHAEL (BB)

(72) Inventors: DAVID D. KINNEY, FENTON, MI (US); JEFFREY D. RICHARDSON, COMMERCE, MI (US)

(21) Appl. No.: 16/691,653

(22) Filed: Nov. 22, 2019

(51) Int. Cl. A47L 13/41; A47L 13/16; B25G 3/38; B25G 3/04

(52) U.S. Cl. CPC A47L 13/41; B25G 3/04; B25G 3/38; A47L 13/16

(57) ABSTRACT

A cleaning device for cleaning an interior surface of a fuel tank includes a handle extending from a first end to a second end, the handle having a grip proximal to the second end which is configured to be grasped by a human hand. The cleaning device also includes a head proximal to the first end of the handle such that the head is fixed to the handle, the head having a magnet fixed thereto. The cleaning device also includes a cleaning pad made of a material which is not attracted to the magnet, the cleaning pad being removably mounted to the head.

### TECHNICAL FIELD OF INVENTION

The present disclosure relates to a cleaning device for cleaning an inside surface of a fuel tank; and more particularly to such a cleaning device which includes a magnet which captures foreign matter which is magnetically attracted to the magnet.

### BACKGROUND OF INVENTION

Internal combustion engines which utilize liquid fuel as a source of energy typically include a fuel tank assembly with a fuel tank which holds a volume of fuel to be supplied to the internal combustion engine for combustion thereby. In addition to the fuel tank, the fuel tank assembly often includes a fuel module disposed within the fuel tank which is used to pump fuel, often using an electric fuel pump, from the fuel tank to the internal combustion engine. The fuel module is inserted into the fuel tank through an opening in the top of the fuel tank which is then closed with a cover to prevent foreign matter from entering the fuel tank through the opening and to prevent fuel from exiting the fuel tank through the opening. Over an extended period of time, or due to a contamination incident, foreign matter, either present in fuel that is added to the fuel tank or from another source, may accumulate at the bottom of the fuel tank which may require cleaning thereof. However, the largest access point to the interior of the fuel tank is by the opening through which the fuel module is inserted, and this is typically only a few inches in diameter. Consequently, cleaning the bottom surface of the fuel tank can be challenging. Furthermore, current methods and devices which are used to clean fuel tanks do not easily capture ferrous foreign matter which may accumulate.

What is needed is a cleaning device for cleaning a fuel tank which minimizes or eliminates one or more of the shortcomings set forth above.

### SUMMARY OF THE INVENTION

Briefly described, the present disclosure provides a cleaning device for cleaning an interior surface of a fuel tank. The cleaning device includes a handle extending from a first end to a second end, the handle having a grip proximal to the second end which is configured to be grasped by a human hand; a head proximal to the first end of the handle such that the head is fixed to the handle, the head having a magnet fixed thereto; and a cleaning pad made of a material which is not attracted to the magnet, the cleaning pad being removably mounted to the head. The cleaning device as described herein allows for thorough cleaning of the fuel tank while magnetically capturing foreign matter which may accumulate within the fuel tank.

### BRIEF DESCRIPTION OF DRAWINGS

This invention will be further described with reference to the accompanying drawings in which:

FIG. 1 is an isometric view of a fuel tank assembly in accordance with the present disclosure;

FIG. 2 is a cross-sectional view of a portion of the fuel tank assembly of FIG. 1;

FIG. 3 is an isometric view of a fuel module of the fuel tank assembly of FIGS. 1 and 2;

FIG. 4 is an isometric view of a cleaning device in accordance with the present disclosure for cleaning a fuel tank of the fuel tank assembly of FIG. 1;

FIG. 5 is the cleaning device of FIG. 4, now shown with a cleaning pad thereof removed;

FIG. 6 is a cross-sectional view of a portion of the cleaning device of FIG. 4; and

FIG. 7 is an isometric view showing the cleaning device being used to clean the fuel tank.

### DETAILED DESCRIPTION OF INVENTION

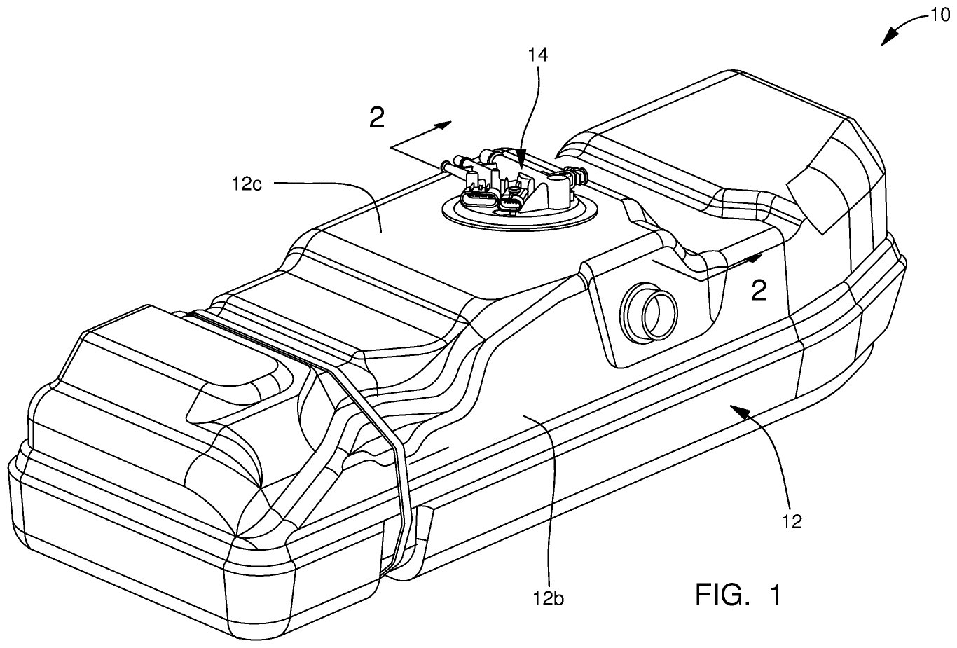

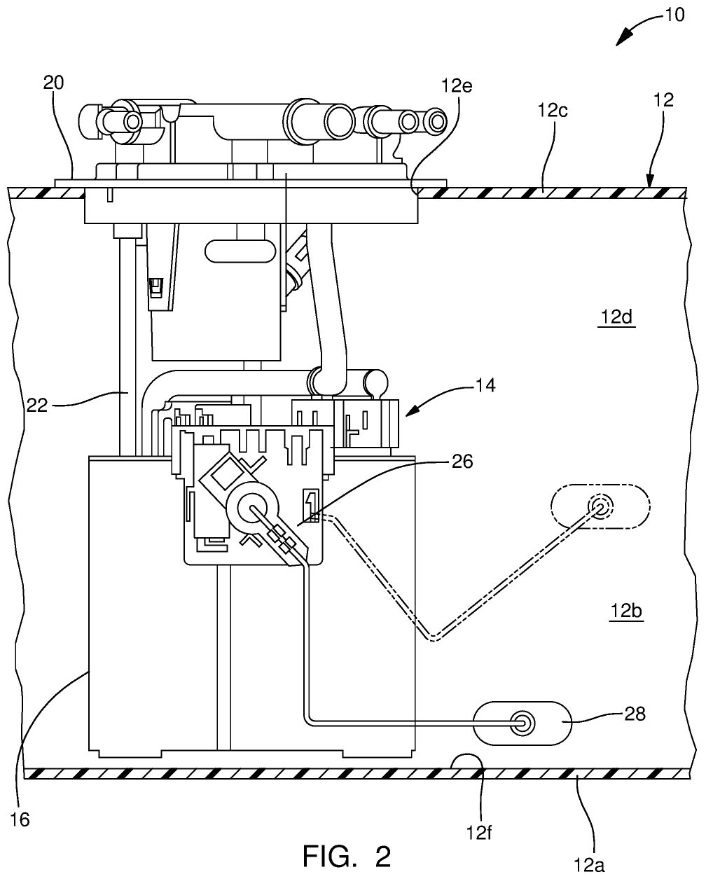

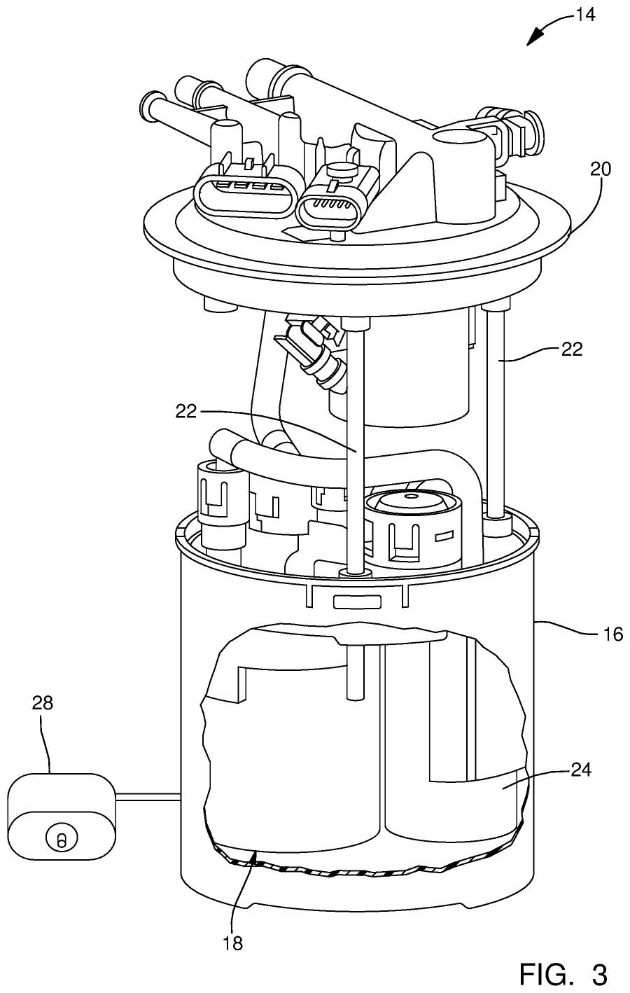

Referring initially to FIGS. 1-3, a fuel tank assembly 10 in accordance with the present disclosure is illustrated for supplying liquid fuel to a fuel consuming device (not shown), for example an internal combustion engine. As is known in the art, the liquid fuel may be, by way of non-limiting example only, gasoline, ethanol, alcohol, diesel fuel, biodiesel, and the like and blends of one or more of the foregoing. Fuel tank assembly 10 includes a fuel tank 12 which holds a volume of the liquid fuel and also includes a fuel module 14 which is used to transfer the liquid fuel from fuel tank 12 to the fuel consuming device.

Fuel tank 12 includes a bottom wall 12a and a sidewall 12b around the periphery of bottom wall 12a such that sidewall 12b extends generally perpendicular to bottom wall 12a. Fuel tank 12 also includes a top wall 12c extending generally perpendicular to sidewall 12b such that top wall 12c is spaced apart from bottom wall 12a, thereby forming an interior space 12d therewithin which holds the volume of liquid fuel. Top wall 12c includes an opening 12e extending therethrough which allows for insertion of a portion of fuel module 14 into interior space 12d such that another portion of fuel module 14 closes off opening 12e as will be described in greater detail later. Fuel tank 12 may be made of a thermoplastic material through a blow molding operation, or may be made of other known materials such as metal.

Fuel module 14 includes a fuel reservoir 16 within which is located an electric fuel pump 18. Fuel reservoir 16 provides a dedicated volume from which fuel pump 18 draws fuel to pump to the internal combustion engine. Fuel reservoir 16 may be filled with fuel from the remaining portions of interior space 12d by known methods, for example, 1) spilling over the top of fuel reservoir 16 when the fuel level of interior space 12d is sufficiently high, 2) by a jet pump (not shown) which is operated by a portion of the output flow of fuel pump 18, and 3) by a one-way valve (not shown) in the floor of fuel reservoir 16). In this way, fuel pump 18 is provided with a supply of fuel, even in conditions where the fuel level in interior space 12d is low or the fuel is caused to be displaced away from fuel module 14, for example due to fuel tank 12 being placed on an incline temporarily or dynamics which tend to cause movement of the fuel, both conditions of which being prominent when fuel tank 12 is included in an automobile which may ascend and descend inclines and which may encounter non-linear paths, accelerations, and decelerations which cause fuel to be displaced within fuel tank 12.

Fuel module 14 also includes a fuel tank cover 20 which is connected to fuel reservoir 16 through connecting rods 22 which allow fuel reservoir 16 to be placed proximal to bottom wall 12a while maintaining fuel reservoir 16 positioned relative to opening 12e. Opening 12e is sized to allow insertion of fuel reservoir 16 and fuel tank cover 20 is sized to close opening 12e, thereby preventing foreign matter from entering interior space 12d through opening 12e and also thereby preventing fuel from escaping interior space 12d through opening 12e.

Fuel module 14 may also include other elements such as a fuel filter 24 which filters fuel that has been pumped by fuel pump 18 and a fuel level sensor 26 which provides a signal indicative of the level of fuel within interior space 12d based on a position of a float 28. Fuel filter 24 may be located within fuel reservoir 16 while fuel level sensor 26 and float 28 may be located outside of fuel reservoir 16 but fixed thereto.

As illustrated herein, fuel tank cover 20 may include various tubes extending therethrough for delivering fuel to the internal combustion engine, returning excess fuel to interior space 12d, and venting interior spaced 12d. Fuel tank cover 20 may also include electrical connectors which are used to provide electrical connection to fuel pump 18 and fuel level sensor 26 for operation thereof.

Fuel modules and their components are well known to those of ordinary skill in the art, one example of which is shown in United States Patent Application Publication No. US 2004/0079149 A1 to Sawert et al., the disclosure of which is hereby incorporated by reference in its entirety. Consequently, fuel module 14 will not be further described herein.

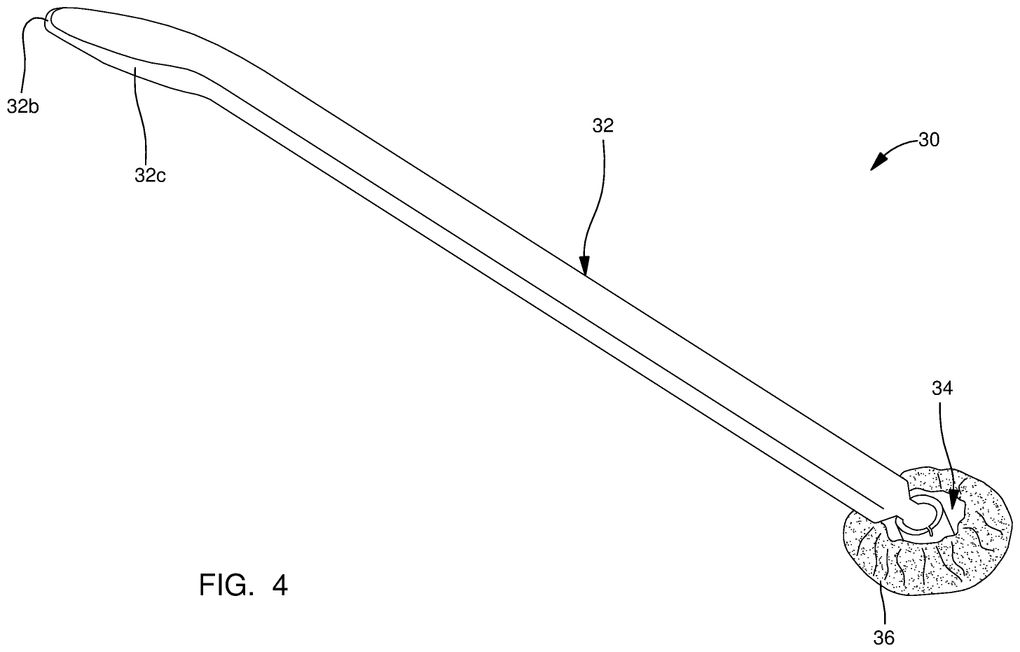

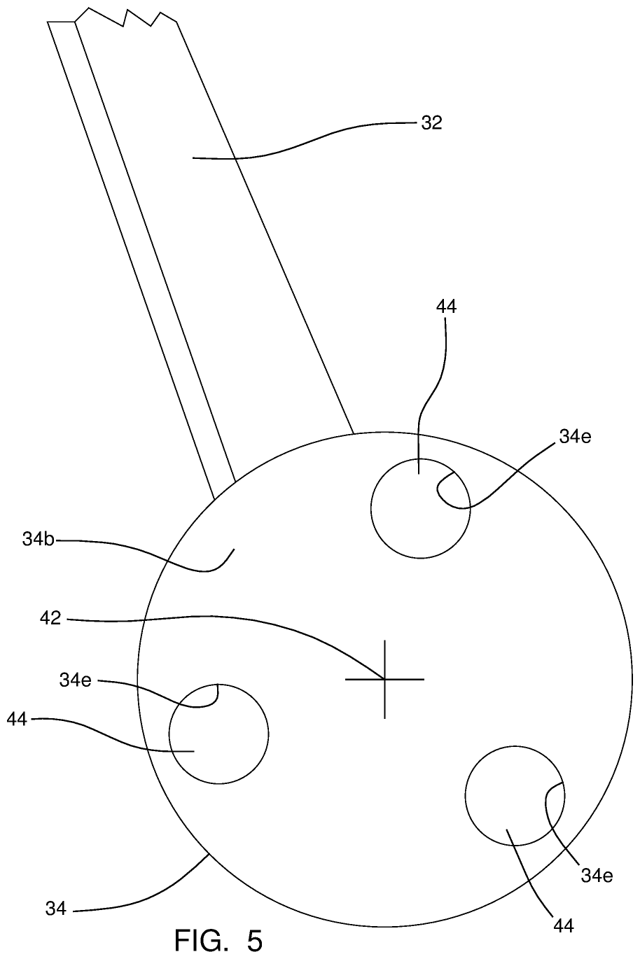

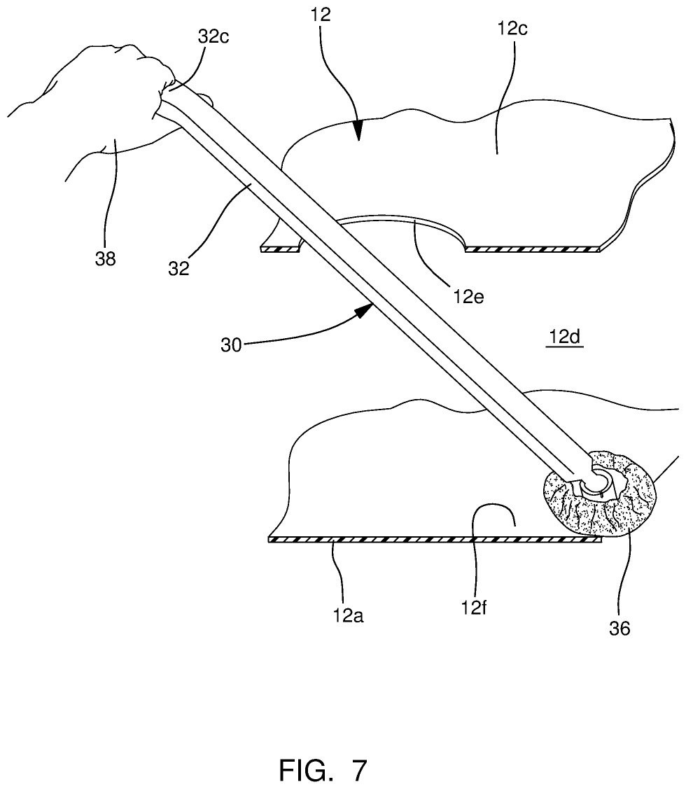

At predetermined service intervals or when fuel module 14 requires service or repair, it may be desirable to clean surfaces of fuel tank 12 which define interior space 12d, particularly a bottom wall interior surface 12f upon which foreign matter may collect over time due to gravity. In order to effectively remove this foreign matter, the present disclosure provides a cleaning device 30 which will be described in the paragraphs that follow with particular reference to FIGS. 4-7.

Cleaning device 30 includes three main elements, namely a handle 32, a head 34, and a cleaning pad 36. Handle 32 extends from a first end 32a, which is proximal to head 34, to a second end 32b which is distal from head 34. Handle 32 includes a grip 32c proximal to first end 32a which is configured to grasped by a human hand 38. As disclosed herein, grip 32c may be any shape, size, and texture which allows the typical human hand to hold and manipulate cleaning device 30 as necessary to move head 34/cleaning pad 36 over bottom wall interior surface 12f in order to scour bottom wall interior surface 12f. As illustrated herein, grip 32c may be angulated relative to the remainder of handle 32 which lies between grip 32c and first end 32a. While grip 32c may be shown at a fixed angle relative to the remainder of handle 32, it should be understood that means may be provided to allow a varied angle between grip 32c and the remainder of handle 32.

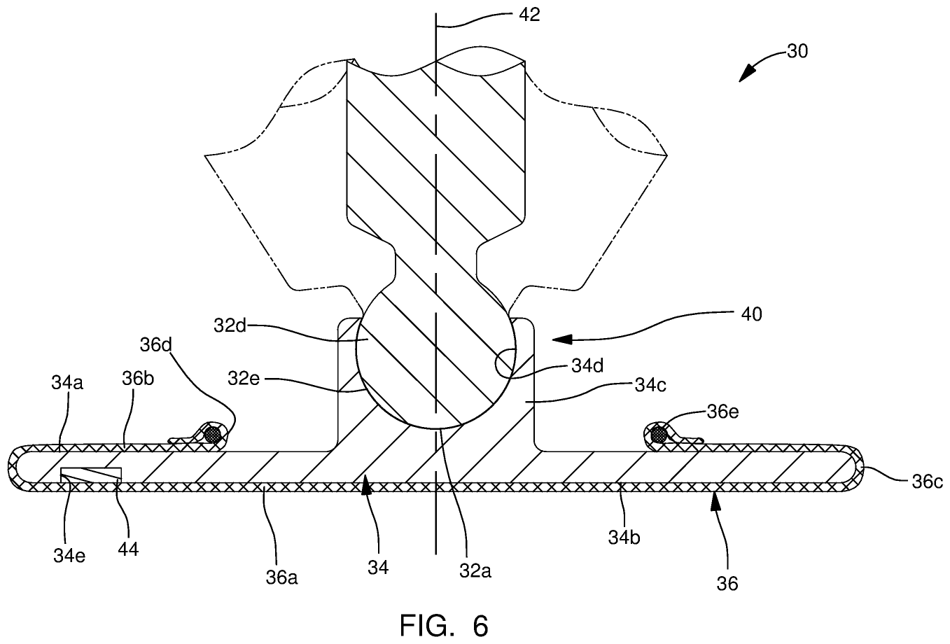

Head 34 is fixed to first end 32a of handle 32, and preferably is fixed thereto with a joint 40 which allows articulation between handle 32 and head 34 which is best shown in FIG. 6 as illustrated by phantom lines. Head 34 includes an upper side 34a and a lower side 34b which is opposed to upper side 34a such that handle 32 is fixed to head 34 at upper side 34a. Lower side 34b is preferably planar as shown in order to allow good engagement between cleaning pad 36, which is supported by lower side 34b, and bottom wall interior surface 12f of fuel tank 12. Head 34 is centered about an axis 42, and may be circular as shown, or may be other shapes, for example, square, rectangular, or triangular.

As illustrated herein, joint 40 may be a ball and socket joint which allows head 34 to pivot in any direction relative to handle 32. Alternatively, joint 40 may be a universal joint, bellows coupling, or any other joint known for providing similar flexibility. In a further alternative, joint 40 may be a simple hinge which only allows pivoting between head 34 and handle 32 about a single axis. In yet another alternative, head 34 may be rigidly fixed to handle 32. In implementation of joint 40 as a ball and socket joint, upper side 34a of head 34 includes a socket 34c with an interior spherical surface 34d. In complementary fashion, handle 32 includes a ball 32d, at first end 32a, with a spherical external surface 32e. Ball 32d is captured within socket 34c by interior spherical surface 34d, thereby retaining head 34 to handle 32 while allowing articulation therebetween.

In order to provide simple manufacturing which minimizes cost, handle 32 and head 34 may each be made in respective plastic injection molding operations which net-form the previously described features of handle 32 and head 34. Joint 40 then allows ball 32d to be snapped into socket 34c in one assembly step.

In order to capture foreign matter that may be attracted by a magnet, for example ferrous foreign matter, head 34 includes one or more magnets 44 fixed thereto. As illustrated herein, each magnet 44 is positioned eccentric to axis 42 and may be arranged in a polar array centered about axis 42. Each magnet 44 is a permanent magnet, and is preferably a rare-earth magnet in order to maximize the strength thereof while minimizing size. Furthermore, each magnet 44 is preferably axially polarized, i.e. having its poles at opposing ends (planar ends) of magnet 44. Each magnet 44 is preferably received in a respective magnet recess 34e of head 34. Retention of magnets 44 in magnet recesses 34e may be accomplished by interference fit and/or adhesives. Alternatively, magnets 44 may be insert molded during a plastic injection molding operation which forms head 34 and may be partially or completely encapsulated. Magnets 44 are proximal to lower side 34b and distal from upper side 34a. Accordingly, magnet recesses 34e extend into head 34 from lower side 34b.

Cleaning pad 36 is shaped complementary to head 34, and as embodied herein, is circular to complement head 34. Cleaning pad 36 is made of a material which is not attracted to magnets 44 and is removably mounted to head 34, thereby allowing cleaning pad 36 to be replaced when has become soiled and no longer effective for cleaning, at which time cleaning pad 36 may be discarded or cleaned for reuse. Cleaning pad 36 is a cloth material which may be woven or non-woven and may be made from natural or synthetic materials or combinations thereof such as cotton, nylon, or paper-based cloth materials. Cleaning pad 36 is preferably made from a lint-free material which does not leave traces of lint when used to scour bottom wall interior surface 12f.

As embodied herein cleaning pad 36 may include a cleaning pad lower portion 36a which is placed adjacent to lower side 34b of head 34. One side of cleaning pad lower portion 36a engages lower side 34b of head 34 while the opposing side of cleaning pad lower portion 36a engages bottom wall interior surface 12f when in use. Cleaning pad 36 may also include a cleaning pad upper portion 36b which is placed adjacent to upper side 34a of head 34. Cleaning pad upper portion 36b is formed of a continuous piece of material with cleaning pad lower portion 36a and joined thereto at a cleaning pad fold 36c which circumferentially surrounds the outer periphery of head 34. Cleaning pad upper portion 36b forms a cleaning pad central opening 36d through which head 34 is inserted. In order to provide retention of cleaning pad 36 to head 34, cleaning pad 36 may be made of an elastic material which can be stretched to allow head 34 to pass through cleaning pad central opening 36d and then return to its original form. Alternatively, cleaning pad 36 may include an elastic cord 36e proximal to cleaning pad central opening 36 which can be stretched to allow head 34 to pass through cleaning pad central opening 36d and then return to its original form. Also alternatively, but not shown, head 34 may include features such as clips or clasps which grip cleaning pad 36 for retention thereof.

While handle 32 has been illustrated herein as being fixed in length, it should be understood that handle 32 may alternatively include features which allow handle 32 to telescope in length in order to accommodate fuel tanks of various sizes. Furthermore, handle 32 may include additional joints which can be locked in position which can further aid in accommodating fuel tanks of various shapes and sizes.

Cleaning device 30 as described herein allows for thorough cleaning of fuel tank 12 while magnetically capturing foreign matter which may accumulate from fuel tank 12, thereby minimizing the likelihood of allowing contamination from reaching fuel pump 18 or other elements of the fuel system and internal combustion engine which subsequently receive fuel.

While the invention has been described by reference to various specific embodiments, it should be understood that numerous changes may be made within the spirit and scope of the inventive concepts described. Accordingly, it is intended that the invention not be limited to the described embodiments, but rather only to the extent set forth in the claims that follow.

We claim:

1. A cleaning device for cleaning an interior surface of a fuel tank, said cleaning device comprising:
a handle extending from a first end to a second end, said handle having a grip proximal to said second end which is configured to be grasped by a human hand;
a head proximal to said first end of said handle such that said head is fixed to said handle, said head having a magnet fixed thereto; and
a cleaning pad made of a material which is not attracted to said magnet, said cleaning pad being removably mounted to said head.

2. A cleaning device as in claim 1, wherein said head includes an upper side and a lower side which is opposed to said upper side such that said handle is fixed to said upper side.

3. A cleaning device as in claim 2, wherein said head is fixed to said handle by a joint which allows articulation between said handle and said head.

4. A cleaning device as in claim 3, wherein said joint is a ball and socket joint.

5. A cleaning device as in claim 4, wherein said upper side of said head includes a socket with an interior spherical surface and said handle includes a ball with a spherical external surface which is captured by said interior spherical surface.

6. A cleaning device as in claim 2, wherein said magnet is proximal to said lower side and distal from said upper side.

7. A cleaning device as in claim 1, wherein:
said head is centered about an axis; and
said magnet is one of a plurality of magnets such that each of said plurality of magnets are eccentric to said axis.

8. A cleaning device as in claim 7, wherein said plurality of magnets are arranged in a polar array centered about said axis.

9. A cleaning device as in claim 7, wherein:
said head includes an upper side and a lower side which is opposed to said upper side such that said handle is fixed to said upper side;
said lower side of said head includes a plurality of magnet recesses extending thereinto such that each one of said plurality of magnet recesses includes a respective one of said plurality of magnets therewithin.
